(19) United States
(12) Patent Application Publication
(10) Pub. No.: US 2025/0083183 A1
(43) Pub. Date: Mar. 13, 2025

(54) MANUFACTURING PROCESS FOR AN ACOUSTIC PANEL

(71) Applicant: XSTONE DESIGN LTD, Exeter (GB)

(72) Inventor: Uwe RIHA, Linkenheim-Hochstetten (DE)

(73) Assignee: XSTONE DESIGN LTD, Exeter (GB)

(21) Appl. No.: 18/883,604

(22) Filed: Sep. 12, 2024

(30) Foreign Application Priority Data
Sep. 13, 2023 (EP) 23197138.3

(51) Int. Cl. B05D 5/00; B33Y 80/00; G10K 11/168

(52) U.S. Cl. CPC B05D 5/00; G10K 11/168; B05D 2201/02; B33Y 80/00

(57) ABSTRACT

A manufacturing process for an acoustic panel including the steps of providing a support made of a sound-absorbing material, applying a mineral filler onto said support, and incorporating a structure into said mineral filler. The present invention further relates to an acoustic panel.

### CROSS-REFERENCE TO RELATED APPLICATION

This application claims the benefit of and priority to European Patent Application No. 23197138.3, filed Sep. 13, 2023, the content of which is incorporated herein by reference in its entirety.

### BACKGROUND

The present invention relates to a manufacturing process for an acoustic panel. The present invention further relates to an acoustic panel and to a method of dampening sound emissions.

Interiors of buildings may sometimes have room acoustics, resulting from their respective size and layout, that people will find disturbing or that prove inappropriate for the intended use of the room. This is particularly true if the room is occupied by a certain number of persons and/or if other or further sound emissions, such as from machines, etc., are present in the room. Devices known as sound absorbers or acoustic panels are employed in order to improve room acoustics or to prepare an interior space for purposes of audio recording. Even at the early stage of planning a room, careful consideration may be given to the conception and arrangement of such elements at suitable locations, with a view to dampening or insulating noise and reverberation.

These sound absorbers or acoustic panels are often in the form of plates or two-dimensional objects that are disposed within the room for sound absorption. Sound energy is thus transformed into other types of energy, such as thermal energy or vibrational energy. This purpose is often achieved by using porous structures such as foam (acoustic foam), wool (rock wool), or PET (polyethylene terephthalate) tiles. The utilization of such structural elements is often combined with a design effect, in particular in office environments, but also in residential or industrial environments. Acoustic panels or sound absorbers are thus also used for purposes of interior design. In this respect, costs are relevant factors, on the one hand, as well as optical appearance and manufacturing possibilities and variability, on the other.

Previous approaches have the disadvantage that the sound absorbers are comparatively conspicuous and cannot be easily integrated into an existing interior environment. With this in mind, the present invention addresses the problem of providing an approach for efficiently improving room acoustics which, on the one hand, enables cost-efficient manufacture and, on the other hand, allows a wide range of different designs in terms of shape and optical appearance.

### SUMMARY

To solve this problem, the present invention, in a first aspect, relates to a manufacturing process for an acoustic panel that includes the steps of:
providing a support made of a sound-absorbing material;
applying a mineral filler onto said support; and
incorporating a structure into said mineral filler.

In another aspect, the present invention relates to an acoustic panel for dampening sound emissions that includes a support having a mineral filler applied thereon and a structure incorporated into the mineral filler, said panel being manufactured, in particular, in a process as described above.

In a further aspect, the present invention relates to a method of dampening sound emissions that includes the step of attaching an acoustic panel as described above to a wall in an interior.

Preferred configurations of the invention will be described in the dependent claims. It is to be understood that the features mentioned above and those yet to be explained further down may not only be used in their respectively specified combination but also in other combinations or alone without departing thereby from the scope of the present invention. In particular, the acoustic panel and the method of dampening sound emissions can be designed in accordance with the configurations for the manufacturing process as described in the dependent claims.

According to the invention, it is proposed that first a support made of a sound-absorbing material is provided. A mineral filler is applied onto this support and a structure is then incorporated therein. The sound-absorbing material itself absorbs sound. In particular, sound energy or sound waves are converted into heat. The mineral filler and the structure incorporated therein will enhance the sound-absorbing effect. This may, in particular, cause reflections or scattering to take place on the surface of the filler, such that a higher proportion of the incident sound can be absorbed by the sound-absorbing material.

The acoustic panel manufactured according to the invention can then be installed in a room, for example on a wall or on the ceiling, in order to improve the acoustic qualities of the room and to contribute to a better spatial experience.

Compared to previous approaches that consisted in using a sound-absorbing material as a sound absorber or in directly using an acoustic panel made of sound-absorbing material without any structure incorporated therein, this results in expanded design options. In addition, sound absorption capabilities may be enhanced. In particular, the manufacturing process according to the invention makes it possible to produce acoustic panels that may resemble a great variety of surfaces and may, for example, have a concrete or stone appearance. This offers a wide range of design options. High sound absorption coefficients are achieved, so that even comparatively small acoustic panels can provide a high degree of effectiveness. In addition, this offers a great deal of creative freedom in design, which ensures suitability for various different applications. Due to the open structure of the mineral filler, sound waves can preferably penetrate the upper covering layer and thus improve the sound insulation of the trigger material. The resulting acoustic panels or boards can be manufactured to fit accurately into one another and can therefore be joined together or mounted without the need for forming joints. In addition, it is possible to digitally print the acoustic panels manufactured according to the invention.

In a preferred configuration, the step of applying the mineral filler involves directly applying it onto the support with a spatula and/or attaching, in particular bonding, a prefabricated veneer onto said support. The prefabricated veneer preferably comprises a filler applied to a glass fiber support. So, on the one hand, it is possible to apply a mineral filler onto the support with the aid of a spatula. On the other hand, a prefabricated veneer may be used in addition or as a supplement. A wider range of different shapes and structures can be achieved, if necessary, by directly applying the filler with a spatula. The use of a prefabricated veneer results in potential cost savings, thus making it possible to achieve greater production efficiency. The acoustic qualities are further improved by the use of a glass fiber support. A prefabricated veneer is then bonded thereto. The bonding can be carried out, for example, by using a suitable bonding agent that does not impair the acoustic qualities.

In a preferred configuration, the step of applying involves applying a filler comprising stone powder and acrylate. By such a mineral filler containing stone powder and acrylate, the acoustic effect may be considerably improved. In addition, surfaces having a stone appearance can be achieved, which opens up a wide range of different design options. The result is a filler that can be processed efficiently and yet is relatively inexpensive to produce. In addition, this results in a wide range of design options.

In a preferred configuration, an oscillating blade, in particular an oscillating tangential blade, and/or a computer-assisted milling machine is/are used for incorporating the structure. By using an oscillating blade, manufacturing may be realized in an efficient and cost-effective manner. The oscillating blade can be used in particular in a cutter machine or in an appropriate, computer-controlled machine for cutting materials. The oscillating blade can be moved in different directions and allows many degrees of freedom when realizing different patterns.

Alternatively, this may also be carried out by a milling operation. However, it has been found that the use of an oscillating blade enables greater efficiency in terms of fast production with low wear and precise processing of cutting edges.

In a preferred configuration, the step of incorporating the structure involves incorporating a structure also into the support. Additionally or alternatively, the step of incorporating the structure involves incorporating a structure having a triangular profile. By incorporating a structure also into the support, the acoustic properties may be further improved. If necessary, the surface of the support can be enlarged. In addition, provision may be made for the applied filler to be completely removed in order to allow direct contact and interaction between the incident sound waves and the support. The filler is, as it were, completely removed from the relevant areas in order to improve the sound ingress properties. Incorporating a structure having a triangular profile has proven to be particularly advantageous as to the sound properties generated thereby. In particular, this leads to the creation of a large surface area. In addition, the incorporating of the structure may be realized in an efficient manner by enabling simple tool selection. In this respect, a triangular profile is to be understood as referring to a triangular cross-section or a tapered furrow or structure.

In one configuration of the manufacturing process according to the invention, the step of incorporating the structure involves incorporating a plurality of oblong recesses that run parallel to one another. The recesses preferably have at least partially a triangular profile. By forming several elongated and parallel recesses, advantageous acoustic qualities can be ensured. The result is a high degree of sound absorption. In addition, this may result in design options that resemble a stone appearance, thus ensuring adaptability to existing structures.

In a preferred configuration, the method comprises a step of printing the acoustic panel, to be performed prior to, or subsequent to, incorporating the structure, preferably subsequent to incorporating the structure. The step of printing preferably comprises printing by means of a digital printing process. An additional printing step enables further design options. This results in a wide range of design options. In addition, integration into existing environments can thus be facilitated and/or made possible. The use of a digital printing process is particularly advantageous, as it enables efficient and cost-effective processing. In addition, this results in precise design options.

In a preferred configuration, the support is provided in the form of a plastic support, in particular a plastic support including a thermoplastic resin, preferably polyethylene terephthalate or polyethylene terephthalate felt. Such supports are also used as acoustic panels or sound absorbers, even without any further structure applied thereon, and have favorable properties in terms of sound absorption. In addition, the mineral filler can be applied thereon in an efficient and permanent manner. Here, the utilization of a felt material is of particular advantage.

In a preferred configuration, the support is provided in the form of a sound insulation panel. Utilizing a sound insulation panel makes it possible to manufacture an acoustic panel according to the invention in a comparatively cost-efficient manner.

In a preferred configuration a support is provided with a thickness of between 5 mm and 24 mm, preferably between 9 mm and 15 mm. Additionally, or alternatively, the step of applying the mineral filler involves applying the latter with a thickness of between 1 mm and 10 mm, preferably between 2 mm and 4 mm. The use of appropriately thick supports and/or layers of mineral filler leads to advantageous acoustic properties in terms of sound absorption. In addition, this results in acoustic panels that may be installed within an interior in a comparatively easy and efficient manner through a method according to the invention for dampening sound emissions.

Here, the term ‘support’ is to be understood, in particular, to refer to a plate, particularly preferably a rectangular or square plate. A filler may, in particular, comprise a mineral powder and a binding agent. The applying operation may, in particular, be carried out with the aid of a spatula. This step may be carried out manually or in an automated manner. In the latter case, an oscillating blade is used in particular in an appropriate machine tool. The incorporated structure is, in particular, two-dimensional (realized at a constant depth within the filler and/or within the support).

### BRIEF DESCRIPTION OF THE DRAWINGS

In the following, the invention will be described and explained in greater detail with reference to a few selected embodiment examples and in connection with the enclosed drawings. In the drawings:

FIG. 1 is a schematic representation of an interior having an acoustic panel attached on a wall of said interior;

FIG. 2 is a schematic representation of an embodiment of an acoustic panel according to the invention;

FIG. 3 is a schematic representation of a manufacturing process according to the invention; and

FIG. 4 is a schematic representation of different structures formed in acoustic panels manufactured according to the invention.

### DETAILED DESCRIPTION

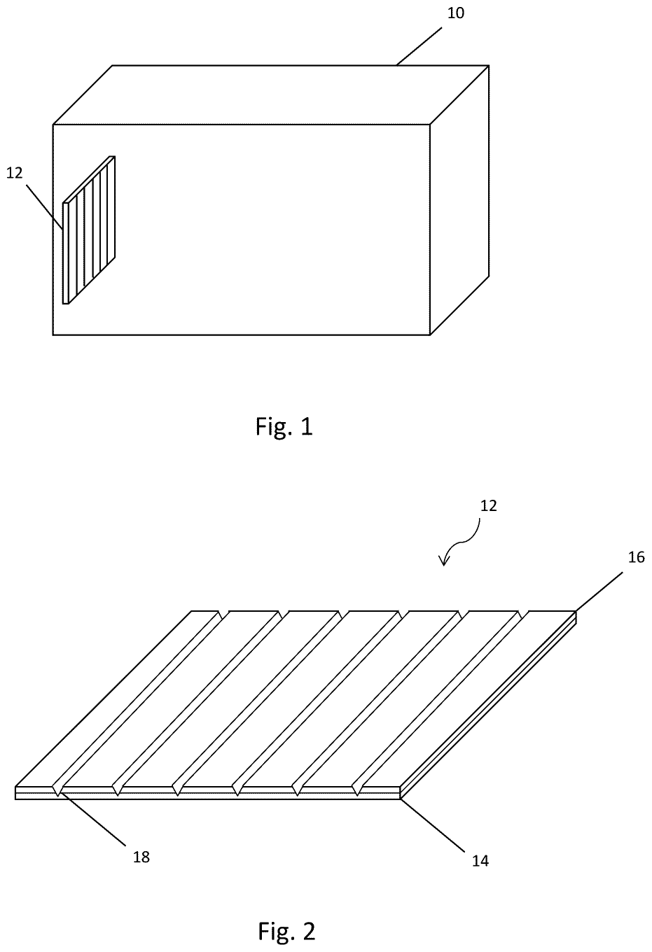

FIG. 1 schematically outlines an interior 10 in which an acoustic panel 12 is attached to a wall. For example, an acoustic panel 12 can be mounted to a wall or ceiling in an office room or else in a living room for the purpose of dampening sound emissions and thus improving the acoustic qualities of the room. The acoustic panel 12 can be mounted, for example, by means of screwing or bonding. A number of such acoustic panels 12 may be mounted next to one another so as to cover a wall completely or to a large extent. The room may also be provided all over with acoustic panels 12 according to the invention.

FIG. 2 schematically shows an acoustic panel 12 according to the invention. In the illustrated embodiment example, the acoustic panel 12 comprises a support 14 onto which a mineral filler 16 has been applied. The acoustic panel 12 has a structure 18 incorporated therein.

The support 14 may, for example, be a plastic support including a thermoplastic resin. For instance, the support may be a PET support or a PET felt support. A mineral filler 16 has been applied onto said support 14, in particular by means of a spatula. This mineral filler 16 may, in particular, be directly applied with a spatula and may comprise stone powder and acrylate. As an alternative to directly applying the mineral filler 16 by means of a spatula, provision may be made for a prefabricated veneer including the filler to be provided, i.e. onto which said filler has been applied. This veneer may then be connected to the support, for example, by means of bonding. The veneer to be employed may, for example, be a glass fiber support. In the illustrated embodiment example, the incorporated structure 18 comprises a plurality of oblong recesses arranged in parallel. In the illustrated embodiment example, the recesses have a triangular profile, are arranged in parallel, and are of straight shape. Obviously, other shapes, profiles, and arrangements can also be provided.

The acoustic panel 12 according to the invention absorbs impinging sound. In particular, the sound is absorbed, on the one hand, by the support 14 made of sound-absorbing material. On the other hand, absorption and/or reflection and scattering will also occur at the mineral filler 16 and/or at the structure 18. The structure 18 may thus serve for increasing the surface area in order to improve the sound-absorbing properties.

FIG. 2 shows an embodiment of an acoustic panel 12 according to the invention in which the structure 18 traverses the layer of the mineral filler 16 in its entirety and extends into the support 14. However, it is also possible that the structure 16 remains within the layer of the mineral filler 16.

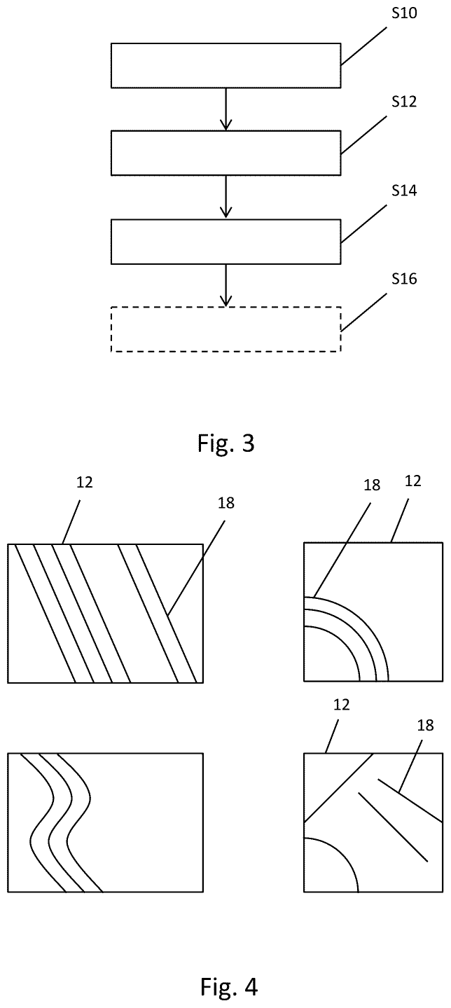

FIG. 3 schematically shows a manufacturing process according to the invention for producing an acoustic panel. The process comprises the steps of providing S10 a support, applying S12 a mineral filler, and incorporating S14 a structure therein. Optionally, the process comprises an additional step of printing S16 the acoustic panel. The method according to the invention may serve, in particular, for producing an acoustic panel as described above. The process may, for example, be carried out in a fully automated or partially automated manner. It may be designed as an operating method for an appropriate manufacturing device. Parts of these steps may also be carried out manually.

The step of incorporating S14 the structure may be performed, in particular, by using an oscillating blade. For example, an oscillating tangential blade can be employed, which is used in an appropriate machine tool. The utilization of an oscillating blade will result in an efficient manufacturability. In addition, this enables various degrees of freedom in selecting the structure. Thus, a great number of possible structures may be realized. So, both straight and curved structures having identical or varying depths can be used. Differently shaped or identically shaped profiles may equally be used.

Optionally, provision may be made for the acoustic panel to be printed. In the embodiment example illustrated in FIG. 3, provision is made for the step of printing S16 to be carried out after the incorporating of the structure. However, it is also possible for the step of printing S16 to be carried out before applying S14 the mineral filler. A digital printing process can be used here, since this enables efficient processability.

FIG. 4 represents four different embodiment examples of acoustic panels 12 according to the invention. In particular, it can be seen from the various representations in FIG. 4 that different forms of supports with mineral filler applied to them can be employed. In addition, different structures 18 may be provided within these supports. The structures 18 can be incorporated into the mineral filler and/or into the support more or less randomly and/or in more or less any desired shapes and depths. The use of an oscillating blade for inserting the structures 18 is particularly advantageous, as this type of tool enables a wide range of different structures 18 to be realized.

The invention has been comprehensively described and explained with reference to the drawings and to the description. The description and the explanation are to be understood as exemplary and not restrictive. The invention is not limited to the disclosed embodiments. Other embodiments or variations will become apparent to those skilled in the art when using the present invention and when thoroughly analyzing the drawings, the disclosure, and the following claims.

In the claims, the words “comprising” and “with/having” do not exclude the presence of further elements or steps. The indefinite article “a” or “an” used in connection with a word does not exclude the existence of a plurality of the items in question. A single element or a single unit can perform the functions of several of the units mentioned in the patent claims. The mere mention of some measures in several different dependent patent claims is not to be understood as meaning that a combination of these measures cannot also be used advantageously. Reference signs in the patent claims are not to be understood restrictively.

1-12. (canceled)

13. A manufacturing process for an acoustic panel including the steps of:
providing a support made of a sound-absorbing material;
applying a mineral filler onto said support; and
incorporating a structure into said mineral filler.

14. The manufacturing process as claimed in claim 13, wherein
said step of applying the mineral filler involves directly applying it onto the support with a spatula and/or attaching, in particular bonding, a prefabricated veneer onto said support.

15. The manufacturing process as claimed in claim 14, wherein said prefabricated veneer comprises a filler applied to a glass fiber support.

16. The manufacturing process as claimed in claim 13, wherein the step of applying involves applying a filler comprising stone powder and acrylate.

17. The manufacturing process as claimed in claim 13, wherein an oscillating blade, in particular an oscillating tangential blade, and/or a computer-assisted milling machine is/are used for incorporating the structure.

18. The manufacturing process as claimed in claim 13, wherein the step of incorporating the structure involves
incorporating a structure into the support; and/or
incorporating a structure having a triangular profile.

19. The manufacturing process as claimed in claim 13, wherein
the step of incorporating the structure involves incorporating a plurality of oblong recesses that run parallel to one another.

20. The manufacturing process as claimed in claim 19, wherein the recesses have at least partially a triangular profile.

21. The manufacturing process as claimed in claim 13, including
a step of printing the acoustic panel, to be performed prior to, or subsequent to, incorporating the structure, preferably subsequent to incorporating said structure.

22. The manufacturing process as claimed in claim 21, wherein the step of printing comprises printing by means of a digital printing process.

23. The manufacturing process as claimed in claim 13, wherein the support is provided in the form of a plastic support.

24. The manufacturing process as claimed in claim 23, wherein, the plastic support includes a thermoplastic resin.

25. The manufacturing process as claimed in claim 24, wherein the plastic support includes polyethylene terephthalate or polyethylene terephthalate felt.

26. The manufacturing process as claimed in claim 13, wherein the support is provided in the form of a sound insulation panel.

27. The manufacturing process as claimed in claim 13, wherein
a support is provided with a thickness of between 5 mm and 24 mm, preferably between 9 mm and 15 mm; and/or
the step of applying the mineral filler involves applying the latter with a thickness of between 1 mm and 10 mm.

28. The manufacturing process as claimed in claim 27, wherein the step of applying the mineral filler involves applying the latter with a thickness of between 2 mm and 4 mm.

29. An acoustic panel for dampening sound emissions that includes a support having a mineral filler applied thereon and a structure incorporated into the mineral filler, said panel being manufactured according to the process of claim 13.

30. A method of dampening sound emissions including the step of attaching an acoustic panel as claimed in claim 29 to a wall in an interior.
